(19) United States
(12) Patent Application Publication
(10) Pub. No.: US 2021/0182452 A1
(43) Pub. Date: Jun. 17, 2021

(54) AUTOMATIC GENERATION OF METAL ROOF PANEL LAYOUT AND CUTTING LISTS FOR MANUFACTURING AND INSTALLATION FROM 3D CAD GEOMETRY

(71) Applicant: J.R. Systems Pty. Ltd. t/a AppliCad, Blackbum (AU)

(72) Inventor: Raymond C. Smith, Blackburn (AU)

(73) Assignee: J.R. Systems Pty. Ltd. t/a AppliCad, Blackburn (AU)

(21) Appl. No.: 16/714,940

(22) Filed: Dec. 16, 2019

(51) Int. Cl. G06F 30/20; G06F 30/13; G06F 40/186

(52) U.S. Cl. CPC G06F 30/20; G06F 2113/24; G06F 40/186; G06F 30/13

(57) ABSTRACT

Systems and methods for automatically generating cutting lists and panel layouts for roofing projects are disclosed. An exemplary system includes a job management service configured to receive user input for material requirements and store the requirements in a job data file. Prior to processing the requirements, the job management service verifies that a roof data file defines a roof geometry. The job data file and roof data file are moved to an active watch folder, wherein a three-dimensional (3D) roof model is automatically generated by a roof generation engine. The roof generation engine automatically generates cut lists and panel layouts based on mapping the material requirements to the 3D roof model.

### TECHNICAL FIELD

The systems and methods disclosed herein relate to the field of generating roofing estimate reports. More particularly, the systems and methods automatically generate cutting lists and panel layouts for roofing projects based on a job requirement.

### BACKGROUND

Computer based systems and methods for calculating roof take-off and estimations are known in the industry. However, a skilled professional, such as a roof estimator, is typically utilized to manually generate a three-dimensional (3D) roof model, extract the material quantity take-off from the 3D roof model, and create a detailed material report and client quotation. As a result, the accuracy of a roof estimate can vary based on the experience of the roof estimator and the roof estimators' subjective determinations when they apply a material representation to the 3D roof model. Furthermore, the complexity of the roof model can increase the time to generate a roof estimate or lead to additional errors. It would be beneficial to automate the calculation of roofing estimates based on a job requirement, so that the outcomes are repeatable and accurate irrespective of the complexity of the roof shape and cost effective.

### SUMMARY

Systems and methods for automatically generating cutting lists and panel layouts for roofing projects are disclosed. An exemplary system includes a job management service configured to receive user input for material requirements stored in a job data file. Prior to processing a job request, the job management service verifies that the roof data file defines three-dimensional roof geometry. Thereafter, the job data file and roof data file are moved to an active watch folder, where a three-dimensional (3D) roof model is automatically generated by a roof generation engine. Thereafter, the roof generation engine automatically generates cut lists and panel layouts based on mapping the material requirements to the 3D roof model. The outcome of the automated roof take-off is the planned and optimized quantification and placement of roof cover materials and their accessories, in order to minimize material waste and labor cost involved in the estimation, quoting, material ordering, and installation phases of roofing projects.

### BRIEF DESCRIPTION OF THE DRAWINGS

The detailed description makes reference to the accompanying figures wherein:

FIG. 1 illustrates an exemplary network and computer system architecture in accordance with the principles disclosed herein.

FIG. 2 illustrates a flowchart depicting an exemplary process in accordance with the principles disclosed herein.

FIG. 3A illustrates a flowchart depicting an exemplary process for a user login in accordance with the principles disclosed herein.

FIG. 3B illustrates a flowchart depicting an exemplary process of configuring a job data file in accordance with the principles disclosed herein.

FIG. 3C illustrates a flowchart depicting an exemplary process of submitting a job data file and roof data file for processing in accordance with the principles disclosed herein.

FIG. 3D illustrates a flowchart depicting an exemplary process of automatically generating a roof estimate report, including a cut list and layout list in accordance with the principles disclosed herein.

FIG. 4 illustrates an exemplary cutting list summary generated in accordance with the principles disclosed herein.

FIG. 5 illustrates an exemplary three-dimensional (3D) roof model generated in accordance with the principles disclosed herein.

The figures are only intended to facilitate the description of the principles disclosed herein. The figures do not illustrate every aspect of the principles disclosed herein and do not limit the scope of the principles disclosed herein. Other objects, features, and characteristics will become more apparent upon consideration of the following detailed description.

### DETAILED DESCRIPTION

A detailed illustration is disclosed herein. However, techniques, methods, processes, systems and operating structures in accordance with the principles disclosed herein may be embodied in a wide variety of forms and modes, some of which may be quite different from those disclosed herein. Consequently, the specific structural and functional details disclosed herein are merely representative.

The flowcharts and block diagrams described in the figures below illustrate the architecture, functionality, and operation of possible implementations of systems, methods, and computer program products according to various embodiments of the principles disclosed herein. In this regard, each block in the flowchart or block diagrams may represent a module, segment, or portion of code, which comprises one or more executable instructions for implementing the specified local function(s). In some alternative implementations, the functions noted in a block may occur out of the order noted in the figures. For example, two blocks shown in succession may, in fact, be executed substantially concurrently, or the blocks may sometimes be executed in the reverse order, depending upon the functionality involved.

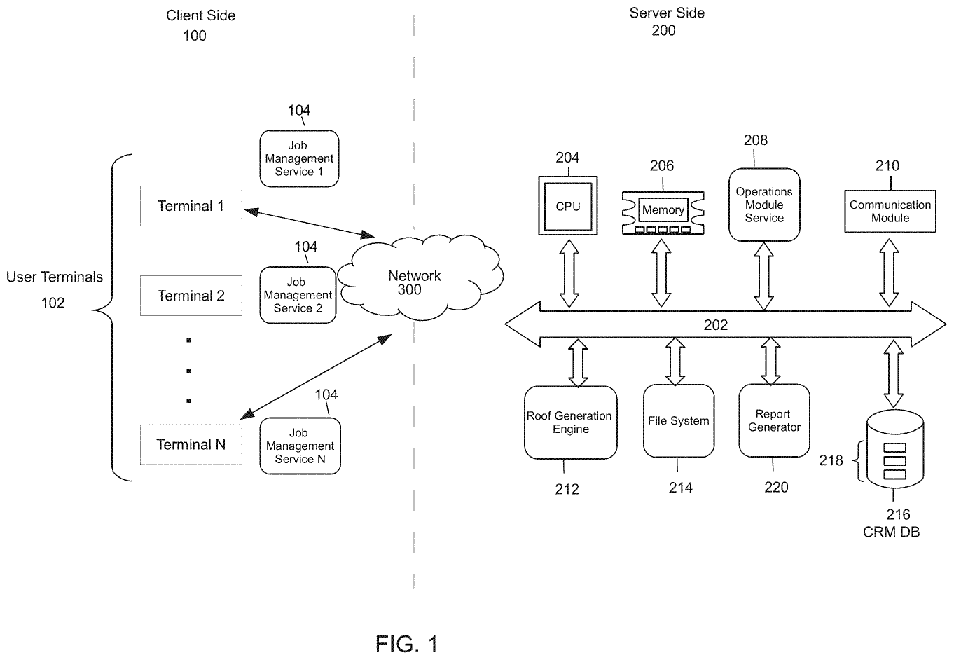

Referring initially to FIG. 1, shown is an exemplary block diagram of a computer system for automatically generating cut lists and panel layouts for roofing projects. Server side 200 can be implemented on hardware or a combination of hardware and software. In this embodiment, the techniques disclosed herein are implemented in a software environment such as an operating system or in an application running on an operation system. This software can include, but is not limited to resident software, firmware, etc. or is implemented on a cloud-based or virtualized network system.

User terminals 102 communicate over network 300 with server side 200. Exemplary user terminals include, but are not limited to, a mobile telephone, cellular telephone, smart telephone, laptop computer, netbook, personal digital assistant (PDA), or any other computing device suitable for network communication. In this embodiment, job management service 104 comprises computer executable instructions and is stored in memory located on user terminal 102. As described in detail below, job management service 102 is configured to receive, process, store, and transmit information between user terminal 102 and server side 200. For example, job management service 102 manages data files defining roof geometry and job data files defining the requirements of a job. Server side 200 utilizes the data files and job data file to automatically generating a cut list and/or panel layout for a roofing project. Therefore, user terminal 102 is configured to execute the computer executable instructions of job management service 102. Several advantages of executing the functionality of job management service 104 on client side 100 include, but are not limited to, improving the responsiveness of user interfaces on user terminal 102, executing functions quicker by limiting the transmission of large data to server side 200, and load balancing, thereby allowing service side 200 to maximize the number of concurrent user terminals 102 connections. It would be apparent to one of ordinary skill in the art to execute the computer executable code and functionality of the job management service on the server side without departing from the principles disclosed herein.

Network 300 can be a local area network (LAN), a wide area network (WAN), the Internet, cellular networks, satellite networks or any other network that permits the transfer and/or reception of data to and/or from server side 200. The data transmitted to or from server side 200 through network 300 can be transmitted and/or received utilizing standard telecommunications protocol or standard networking protocol. In the embodiment shown in FIG. 1, the system utilizes Transmission Control Protocol/Internet Protocol (TCP/IP) and network 300 is the Internet. Other examples of protocols for transmitting and/or receiving data include, but are not limited to, Voice Over IP (VOIP) protocol, Short Message Service (SMS), and Global System for Mobile Communications (GSM). Network 300 is capable of utilizing one or more protocols of client side 100 and server side 200. Furthermore network 300 can translate to or from other protocols to one or more protocols of user terminals 102. As a result, a user can seamlessly transition from one device to another and continue preparing jobs for server side 200.

Shown in FIG. 1 is an exemplary block diagram depicting a computer system architecture for implementing server side 200. At least one computer processing unit (CPU) 204 and at least one memory 206 are interconnected to bus 202. Communication Module 210 is configured to allow server side 200 to communicate through network 300 with user terminals 102 terminals. Further, the computer system architecture comprises operations module service 208, roof generation engine 212, file system 214, and report generator 220. File system 214 comprises a software-defined media file system and is configured to store job data files, roof data files, and generated reports. Further, file system 214 comprises at least one active watch folder. The at least one active watch folder is continuously monitored by CPU 204, thereby allowing the computer architecture system to establish rules for processing files placed into the at least one active folder. As a result, server side 200 can automatically process the job data files and roof data files transmitted by job management service 104 to generate reports in accordance with the principles disclosed herein.

Operations module service 208 is configured to evaluate job data files and roof data files submitted by job management service 104 to server side 200. Operation module service 208 registers the arrival of new job data files and roof data files received for roof generation engine 212 to process. As described in detail below, roof generation engine 212 is configured to generate a three-dimensional (3D) roof model from roof data files. Thereafter, roof generation engine 212 automatically generates a cut list, panel list, and accessory list based on mapping the material requirements in the job data file to the 3D roof model. Exemplary materials that roof generation engine 212 can process include, but are not limited to, sheet metal (such as aluminum, steel, etc.), tiles (clay, concrete, composite), shakes (timber, metal, composite), and shingles (asphalt, metal). Report generator 220 is configured to generate a report on the cut list, panel list, and accessory list generated by the roof generation engine 212.

The computer system architecture further includes at least one database. The database can store data over one or multiple databases. Customer Relationship Management (CRM) database 212 comprises at least one user profile 214. User profile 214 securely stores various information about a user, including but not limited to, login credentials, contact information, and a history of the job data files requested.

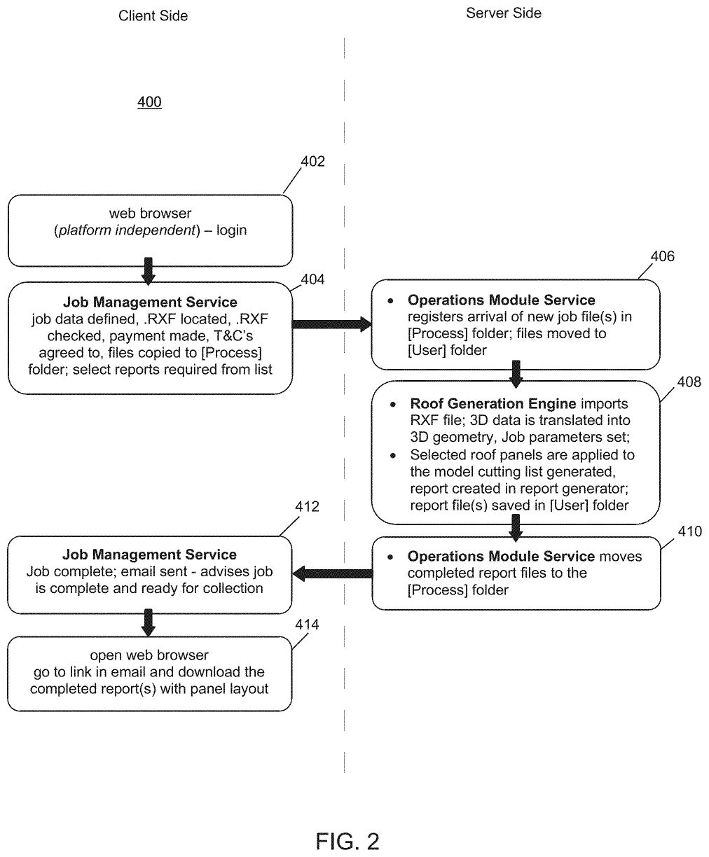

In FIG. 2, flow chart 400 depicts an exemplary overview of a user experience in accordance with the principles disclosed herein. First in step 402 the user logs into a web portal to access the systems and methods disclosed herein. Logging into the web portal downloads an instance of the job management service into the memory of the user's terminal. Therefore, the job management service is locally executed on the user's terminal.

In step 404, the user utilizes the job management service to define the project requirements in a job data file. Exemplary project requirements include defining the required trim of the roof system, material gauge, supplier name, and the material finish. The user also locates and associates a roof data file with the job data file. An RXF (Roof Exchange File) data file is an exemplary roof data file. Typically, an RXF data file describes the geometry of a roof as a three-dimensional structure with attributes defining the function of the roof edges, eave lines, hip lines, valley lines, and type of roof cladding to be applied (e.g., metal, tile, shingle, slate, single ply etc.). The representation of the three-dimensional structure can comprise a plurality of vectors. Multiple different job data files can be associated with a roof data file without departing from the principles disclosed herein. Furthermore, the user can configure the system to process different roof data files that use the same job data file in order to save time.

In step 404, the user can configure the format of the report that is automatically generated by server side. To move to the next step, the user is required to accept the terms of service and submit a valid payment. Thereafter, the job management service transfers the job data file and roof data file to the server side.

As shown in step 406, the job data file and roof data file are placed in the [Process] folder located on the server-side. The [Process] folder is an active watch folder. As a result, the operations module service can register the arrival of new files and automatically move the job data file and the roof data file to a [User] folder for processing, without additional input from the user. The [User] folder is also an active watch folder.

Therefore, in step 408, the roof generation engine registers the arrival of new files and automatically generates a three-dimensional (3D) roof model of the roof data file. The roof generation engine also automatically generates cut lists and panel layouts. Thereafter, a report is generated by the report generator based on the generated cut lists and panel layouts. Additional information from the job data file can also be included in the report. The report generator stores the report in the [User] folder.

In step 410, the operations module service registers the addition of the new report, because the [User] folder is an active watch folder. In turn, the operations module services moves the generated report to the [Process] folder. In step 412 the job management service registers the generated report placed in the [Process] and automatically notifies the user to access the generated report in step 414. In circumstances where multiple jobs are submitted to the system, multiple instances of the operations module service can operate concurrently on the server-side with their own respective instance of the roof generation engine, monitoring the [Process] folder.

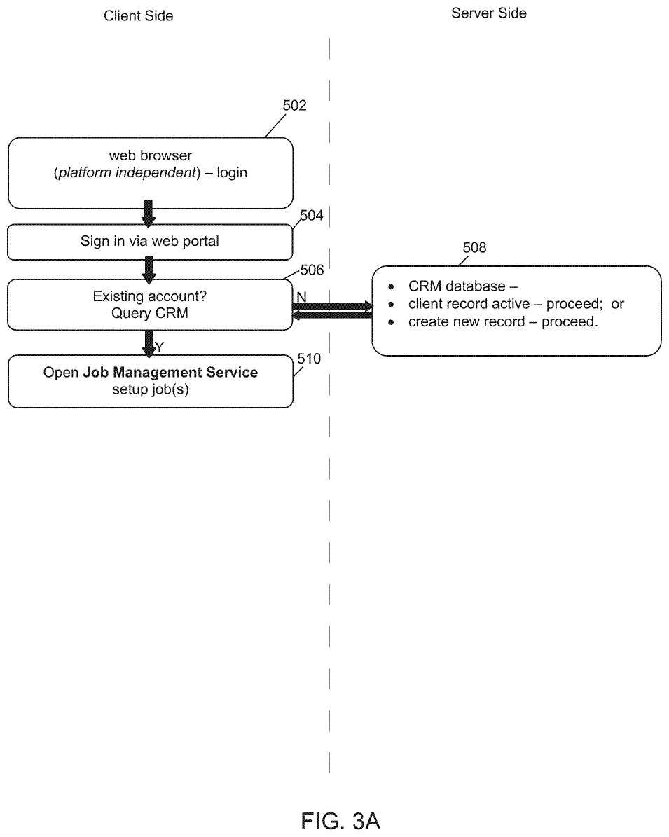

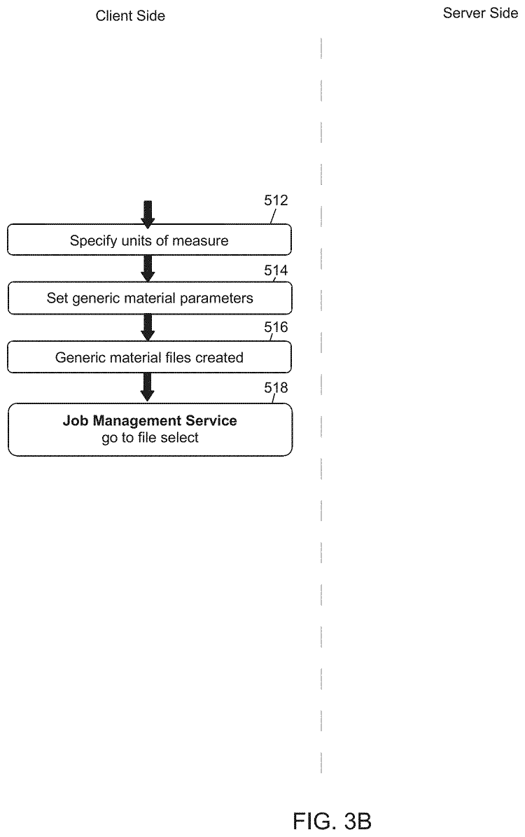

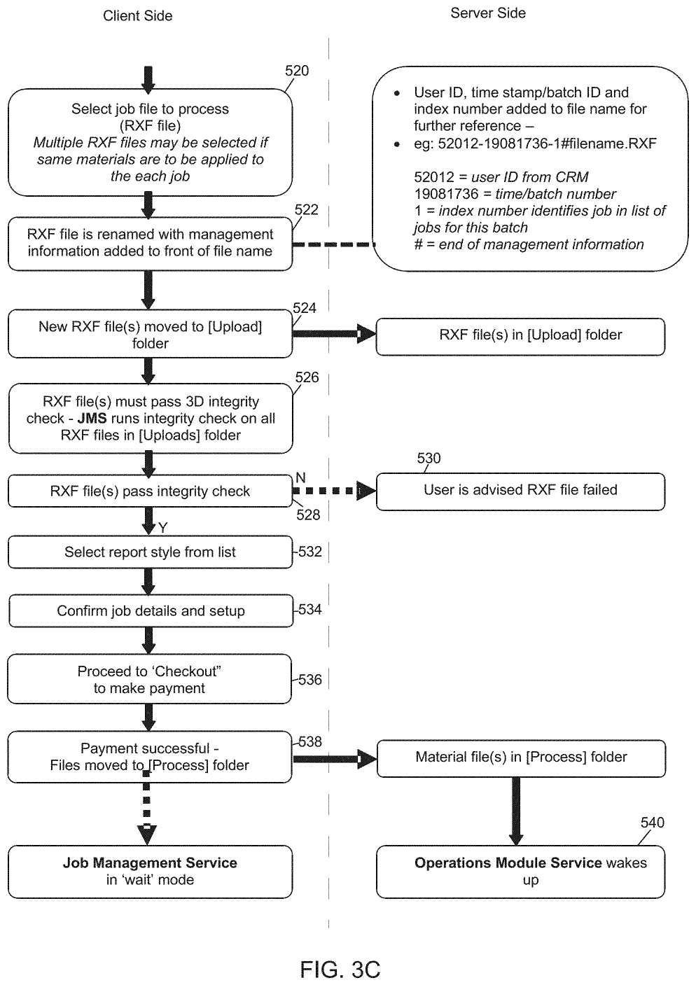

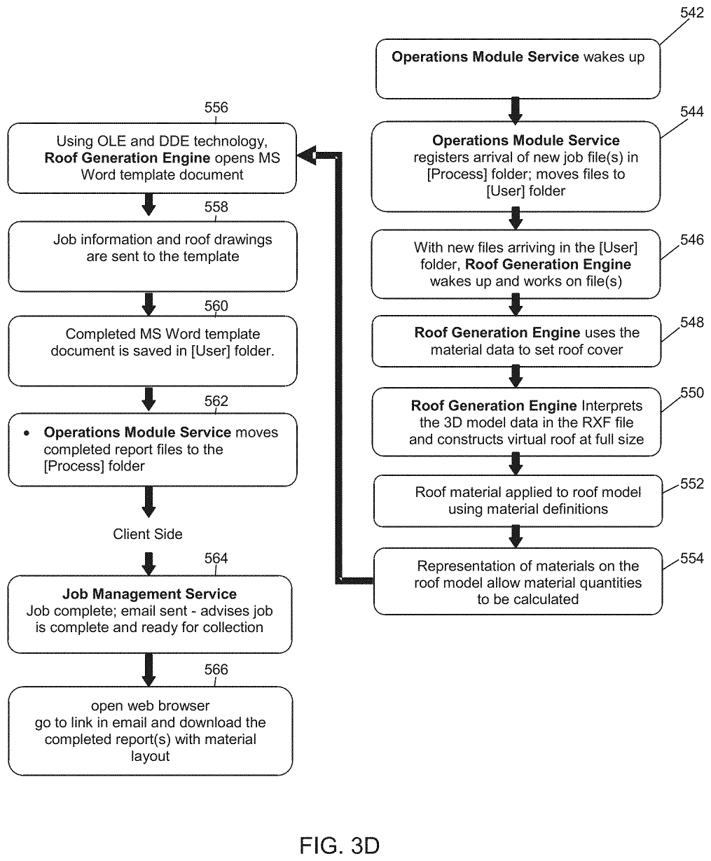

FIGS. 3A-3D, depict flow charts and block diagrams representing additional details of an exemplary user experience in accordance with the principles disclosed herein. In FIG. 3A, an exemplary user login process is shown. In step 502, the user utilizes a web browser to access the web portal for the systems and methods disclosed herein. Thereafter, the user is prompted to enter a username and credentials to sign in to the web portal in step 504. In step 506, the client-side job management service queries the server-side CRM database to confirm the existence of an account or proceed to step 508 to direct the user to create an account. Once registered or logged in to an existing account, the user is guided through various data entry prompt screens by the client-side job management service in step 510. As described in detail below with reference to FIG. 3C, the user's account ID is utilized for scheduling the various jobs on the server-side for automatically generating cutting lists and panel layouts for roofing projects.

In FIG. 3B, shown is an exemplary process for configuring a job data file in accordance with the principles disclosed herein. In step 512 and step 514, the user enters details including, but not limited to, the job site address and end customer's name, units of measure, material type, gauge, minimum and maximum lengths, suppliers' names, finishes, and the panel cover width. Typically, the user will also define the required roof trim, the trim's stock length for their roof system, gauge, description, supplier name and material finish. The details entered in this process can be configured to be displayed in the report generated. In step 516, a job data file is created. Thereafter, in step 518 the job management service prompts the user to select a roof data file.

Shown in FIG. 3C is an exemplary process of the client side job management service verifying a requested job. In step 520, the user selects a roof data file to associate with the job data file created in the previous steps. An RXF data file is an exemplary roof data file. An RXF data file can be created by the user or acquired from various commercial service providers. Typically, an RXF data file describes the geometry of a roof as a three-dimensional structure with attributes defining the function of the roof edges, eave lines, hip lines, valley lines, and type of roof cladding to be applied (e.g., metal, tile, shingle, state, single ply etc.). Multiple RXF data files can be selected in a circumstance where the same materials defined in the job data file is going to be applied.

In step 522, the roof data file is renamed to include management information. For example a User ID, time stamp/batch id and job index number can be added. Therefore, the server-side can manage the scheduling of various jobs utilizing file names. It would be apparent to one of ordinary skill in the art to use other methods for scheduling jobs, for example a scheduling database, without departing from the principles disclosed herein.

In step 524, the selected roof data file is moved to an [Upload] folder on the client-side and an [Upload] folder on the server side. Next, in step 526, the client-side job management service automatically performs an integrity check on the roof data file located on the client-side [Upload] folder. The purpose of the integrity check is to verify that the roof geometry data in the roof data file comprises three-dimensional data. Some roofing software systems only produce two-dimensional model data, which are not sufficient for this process. To the extent that the integrity check fails the user is notified in step 530 by the job management service. Once the roof data file passes the integrity check in step 528, the user is directed to a portal page in step 532 reporting the success and directed to select a reporting style. Thereafter, in step 534, the user is asked to confirm the job details and read and agree to the terms and conditions of the service. Exemplary terms and conditions can highlight that the accuracy of the output results are dependent upon the accuracy of the roof data file and other data supplied by the user and any subsequent use of the output results are subject to the user confirming the details via a physical site measure.

In step 536, the user proceeds to check-out and make a payment. Various pricing models can be utilized by the service including, but not limited to, a fixed price per individual jobs or a subscription model. After the payment is successful, in step 538, the client-side job management service moves the job data file and the associated roof data file to a [Process] folder located on the server-side. The [Process] folder is an active watch folder. Furthermore, the job management service is configured into a wait mode for a response from the server-side on the job request. In step 540, the server-side wakes up an instance of the operations module service to automatically schedule and process the requested job.

Turning next to FIG. 3D, shown is a flowchart depicting an exemplary process of the server-side automatically generating a roof estimate report. In step 542, an instance of the operations module service is woken up. The operations module service is configured to register the arrival of new files placed into the server-side [Process] folder and automatically schedule the processing of the job request. In step 544, the operations module service moves the new files placed in the [Process] folder to a [User] folder located on the server-side. The [User] folder is an active watch folder. The roof generation engine is configured to register the arrival of new files in the [User] folder.

In step 546, the roof generation engine wakes up an instance to automatically process the new files located in the [User] folder. In step 548, the roof generation engine uses the material data in the job data file to set the roof cover. In step 550, the roof generation engine generates a three-dimensional (3D) roof model from roof data file located in the [User] folder. The 3D roof model is reproduced at full scale. Next in step 552, the roof generation engine applies the material data to the 3D roof model. Thereafter, in step 554 the roof generation engine utilizes the representation of the materials applied to the 3D roof model to calculate the quantities of the materials. Further, the roof generation engine calculates cutting lists and panel layouts.

In step 556, roof generation engine opens a template document for generating a report. The template can be a Word Processor template. Next in step 558, the job data file and the information generated by the roof generation engine are transferred to the report template by the report generator. Object Linking and Embedding (OLE) technology and/or Dynamic Data Exchange (DDE) technology can be utilized to transfer information to the template. Further, the report generator can use a series of ‘key text string’ (KTS) variables embedded in the template to exchange information with the template including, but not limited to, the cutting list table, customers name, address, phone, job number, and job date. KTS variables can comprise commands interpreted by the report generator. For an exemplary KTS variable entitled ###Compname, the report generator identifies the subject of the key (the name of the Company in this example), finds the detail in the job data file, and places that detail into the template in the place of the key text. In step 560, the report generator completes generating the report and stores the report in the [User] folder located on the server-side. Thereafter, in step 562, the operations module service moves the completed report file to the [Process] folder.

In step 564, the client side job management service registers the arrival of the completed report in the [Process] folder and generates a notification to the user. The notification can be an e-mail, text, or voice message. Next, in step 566, the user can open a web browser and access the completed report.

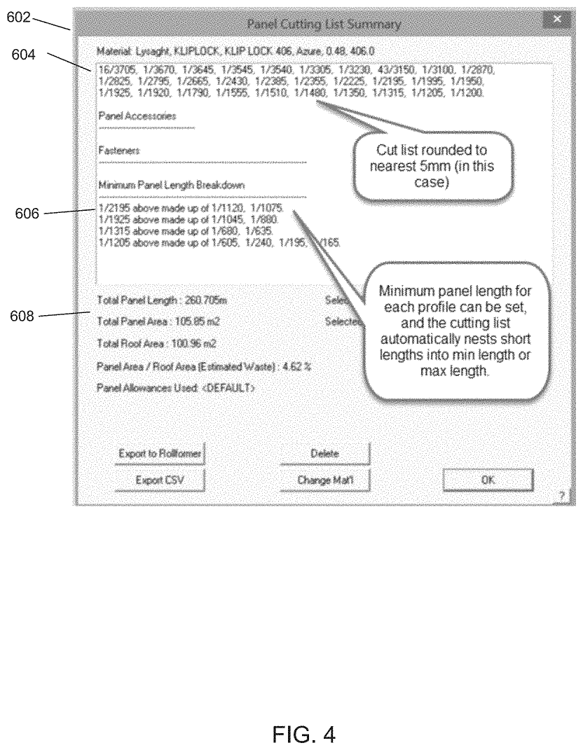

FIG. 4, illustrates an exemplary cutting list summary generated by roof generation engine in accordance with the principles disclosed herein. The information displayed on user interface 602 is typically presented in a report generated from a template by the report generator. In certain circumstances, interface 602 can be displayed to users without departing from the principles disclosed herein. As shown in FIG. 4, interface area 604 displays the materials and the cut list rounded to the nearest 5 mm. Interface area 606 displays a summary of the minimum panel lengths. The cut list rounding and the minimum panel length can be configured in the job data file. Finally, interface area 608 displays a summary of the totals. The cutting list is created showing total length of metal coil required for manufacturing, total panel area (with appropriate multiplier for the material gauge, which is used to calculate material mass for shipping), and the expected waste factor as a result of unused offcuts at hips, valleys, and gable ends. All of this information can be included in the report generated by the report generator.

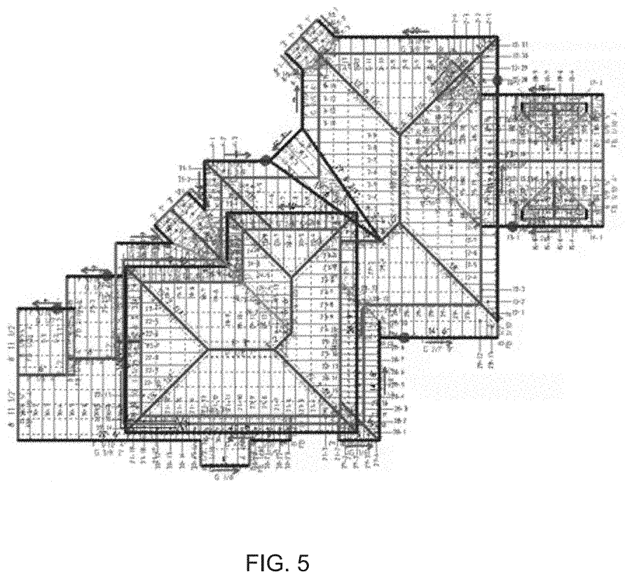

Turning to FIG. 5, shown is an exemplary 3D roof model. The roof generation engine interprets the three-dimension data in an RXF file and translates the 3D data into a full size working 3D roof model. Further, the roof generation engine can then read the material definitions and other settings defined in a job data file and populate the material definition information. The material definition information is utilized by the roof generation engine in order to apply these materials to the 3D roof model. As shown in FIG. 5, the roof generation engine proceeds to generate a panel layout using the panel cover width as the key specification for the panel layout. All of this information can be included in the report generated by the report generator.

The detailed description is not intended to be limiting or represent an exhaustive enumeration of the principles disclosed herein. It will be apparent to those of skill in the art that numerous changes may be made in such details without departing from the spirit of the principles disclosed herein.

What is claimed is:

1. A computer system for automatically generating cut lists and panel layouts for roofing materials comprising:
a user terminal,
a job management service configured to define at least one job data file and access at least one roof data file defining a roof geometry;
a software-defined storage media file system that stores the at least one job data file and at the least one roof data file in an active watch folder;
an operations module service configured to automatically register the arrival of the at least one job data file in the active watch folder, and move the at least one job data file to a user directory;
a roof generation engine configured to automatically register the arrival of the at least one job data file to the user directory, generate a three-dimensional (3D) roof model from the at least one roof data file, and automatically generate cut lists and panel layouts utilizing the at least one job data file and the 3D roof model; and
a report generator configured to generate a report of the cut lists and panel layouts.

2. The computer system of claim 1, wherein the user terminal comprises memory and the user terminal is configured to store and execute the job management service in the memory.

3. The computer system of claim 1, wherein the job management service is configured to perform a verification of the at least one roof data file for a three-dimensional (3D) structure and generate a notification to the user terminal.

4. The computer system of claim 1, wherein the report generator automatically generates a report by opening a template and populating the template based on a plurality of ‘key text string’ variables embedded in the template.

5. The computer system of claim 4, wherein the template comprises a Word Processor template file.

6. The computer system of claim 1, wherein the operations module service is configured to automatically move a generated report to the active watch folder, and wherein the job management service is configured to register the arrival of the generated report in the active watch folder and generate a notification to the user terminal to retrieve the generated report.

7. The computer system of claim 1, wherein the job data file comprises a material definition and the roof generation engine applies the material definition to generate a representation of materials on the 3D roof model and calculate a quantity of the material definition.

8. The computer system of claim 7, wherein the material definition comprises formed sheet metal.

9. The computer system of claim 1, wherein the at the least one roof data file comprises a plurality of vectors defining a three-dimensional (3D) structure.

10. A non-transitory computer-readable storage device storing computer executable instructions that when executed by a computer controls the computer to perform a method for automatically generating cut lists and panel layouts for roofing materials, the method comprising:
receiving at least one job data file and at least one roof data file defining the geometry of a roof from a job management service;
storing the at least one job data file and the at least one roof data file on an active watch folder;
automatically registering the storage of the at least one job data file in the active watch folder and moving the at least one job data file to a user director;
automatically registering the arrival of the at least one job data file to the user directory and generating a three-dimensional (3D) roof model from the at least one roof data file;
automatically generating cut lists and panel layouts from a roof generation engine;
automatically generating a report based on the cut lists and panel layouts; and
automatically transferring the report to the job management service.

11. The non-transitory computer-readable storage device of claim 10, wherein automatically generating a report based on the cut lists and panel layouts, comprises opening a template and populating the template based on a plurality of ‘key text string’ variables embedded in the template.

12. The non-transitory computer-readable storage device of claim 10, wherein receiving at least one job data file and at least one roof data file defining the geometry of a roof from a job management service, comprises verifying that the at least one roof data file comprises a three-dimensional (3D) structure.

13. The non-transitory computer-readable storage device of claim 10, wherein automatically generating cut lists and panel layouts from a roof generation engine, comprises generating a representation of materials on the 3D roof model and calculating a quantity of the material.

14. The non-transitory computer-readable storage device of claim 11, the method further comprising, generating accessory lists from a roof generation engine.

15. The non-transitory computer-readable storage device of claim 14, the method further comprising, generating a report based on the accessory list.

16. A system comprising:
at least one user terminal configured to execute a job management service in a local memory;
a server-side software-defined storage media file system comprising at least one active watch folder;
a server-side operations module service configured to automatically process at least one job data file transmitted from the job management service;
a roof generation engine configured to automatically generate a three-dimensional (3D) roof model from at least one roof data file; and
a report generator configured to generate a report comprising cut lists and panel layouts generated by the roof generation engine.

17. The system of claim 16, further comprising a payment system.

18. The system of claim 16, wherein the job management service is configured to perform a verification of the at least one roof data file for a three-dimensional (3D) structure.

19. The system of claim 16, wherein the report generator automatically generates a report by opening a template and populating the template based on a plurality of ‘key text string’ variables embedded in the template.

20. The system of claim 16, wherein the server-side operations module service is configured to automatically move a generated report to the active watch folder, and wherein the job management service is configured to register the arrival of the generated report in the active watch folder, and generate a notification to the user terminal to retrieve the generated report.
